(19) United States
(12) Patent Application Publication
(10) Pub. No.: US 2015/0142709 A1
(43) Pub. Date: May 21, 2015

(54) AUTOMATIC LEARNING OF BAYESIAN NETWORKS

(71) Applicant: Sikorsky Aircraft Corporation, Stratford, CT (US)

(72) Inventors: Tuhin Sahai, Cambridge, MA (US); Stefan Klus, Hartford, CT (US)

(21) Appl. No.: 14/546,392

(22) Filed: Nov. 18, 2014

Related U.S. Application Data
(60) Provisional application No. 61/906,046, filed on Nov. 19, 2013.

(51) Int. Cl. G06N 99/00; G06N 7/00

(52) U.S. Cl. CPC G06N 99/005; G06N 7/005
USPC 706/12

(57) ABSTRACT

A method of learning a structure of a Bayesian network includes computing an ordering of the random variables of the Bayesian network; wherein computing the ordering of the random variables of the Bayesian network is performed by computing an approximate solution to the history dependent traveling salesman problem.

### CROSS-REFERENCE TO RELATED APPLICATIONS

This application claims the benefit of U.S. provisional patent application Ser. No. 61/906,046 filed Nov. 19, 2013, the entire contents of which are incorporated herein by reference.

### BACKGROUND

Bayesian networks belong to the class of probabilistic graphical models and can be represented as directed acyclic graphs (DAGs). Bayesian networks have been used extensively in a wide variety of applications, for instance for analysis of gene expression data, medical diagnostics, machine vision, behavior of robots, and information retrieval to name a few.

Bayesian networks capture the joint probability distribution of the set χ of random variables (nodes in the DAG). The edges of the DAG capture the dependence structure between variables. In particular, nodes that are not connected to one another in the DAG are conditionally independent. Learning the structure of a Bayesian network is a challenging problem and has received significant attention. It is well known that given a dataset, the problem of optimally learning the associated Bayesian network structure is NP-hard. Several methods to learn the structure of Bayesian networks have been proposed over the years. Arguably, the most popular and successful approaches have been built around greedy optimization schemes. Exact approaches for learning the structure of Bayesian networks have a scaling of O(n2ⁿ+n^{k+1}C(m)), where n is the number of random variables, k is the maximum in-degree and C(m) is a linear function of the data size m. These approaches are based on solving a dynamic program. For large Bayesian networks, the above scaling for exact algorithms is prohibitive.

### BRIEF DESCRIPTION

An exemplary embodiment includes a method of learning a structure of a Bayesian network, the method including computing an ordering of the random variables of the Bayesian network; wherein computing the ordering of the random variables of the Bayesian network is performed by computing an approximate solution to the history dependent traveling salesman problem.

In addition to one or more of the features described above or below, or as an alternative, further embodiments could include applying the traveling salesman problem algorithm by applying a Lin-Kernighan heuristic.

In addition to one or more of the features described above or below, or as an alternative, further embodiments could include applying the traveling salesman problem algorithm by applying a cutting plane method.

In addition to one or more of the features described above or below, or as an alternative, further embodiments could include applying the traveling salesman problem algorithm by considering random variables of the Bayesian network as cities of a tour and the optimal ordering of random variables as a tour that minimizes overall cost.

In addition to one or more of the features described above or below, or as an alternative, further embodiments could include applying the traveling salesman problem algorithm by performing a general k-opt iteration on the Bayesian network.

Another exemplary embodiment includes an apparatus for learning a structure of a Bayesian network, the apparatus including a processor; and memory comprising computer-executable instructions that, when executed by the processor, cause the processor to perform operations for learning the structure of the Bayesian network, the operations comprising: computing an ordering of the random variables of the Bayesian network; wherein computing the ordering of the random variables of the Bayesian network is performed by computing an approximate solution to the history dependent traveling salesman problem.

In addition to one or more of the features described above or below, or as an alternative, further embodiments could include applying the traveling salesman problem algorithm by applying a Lin-Kernighan heuristic.

In addition to one or more of the features described above or below, or as an alternative, further embodiments could include applying the traveling salesman problem algorithm by applying a cutting plane method.

In addition to one or more of the features described above or below, or as an alternative, further embodiments could include applying the traveling salesman problem algorithm by considering random variables of the Bayesian network as cities of a tour and the optimal ordering of random variables as a tour that minimizes overall cost.

In addition to one or more of the features described above or below, or as an alternative, further embodiments could include applying the traveling salesman problem algorithm by performing a general k-opt iteration on the Bayesian network.

Another exemplary embodiment includes a computer program product tangibly embodied on a non-transitory computer readable medium for learning a structure of a Bayesian network, the computer program product including instructions that, when executed by a processor, cause the processor to perform operations including: computing an ordering of the random variables of the Bayesian network; wherein computing the ordering of the random variables of the Bayesian network is performed by computing an approximate solution to the history dependent traveling salesman problem.

In addition to one or more of the features described above or below, or as an alternative, further embodiments could include applying the traveling salesman problem algorithm by applying a Lin-Kernighan heuristic.

In addition to one or more of the features described above or below, or as an alternative, further embodiments could include applying the traveling salesman problem algorithm by applying a cutting plane method.

In addition to one or more of the features described above or below, or as an alternative, further embodiments could include applying the traveling salesman problem algorithm by considering random variables of the Bayesian network as cities of a tour and the optimal ordering of random variables as a tour that minimizes overall cost.

In addition to one or more of the features described above or below, or as an alternative, further embodiments could include applying the traveling salesman problem algorithm by performing a general k-opt iteration on the Bayesian network.

### BRIEF DESCRIPTION OF DRAWINGS

FIG. 1a depicts a structure learning of Bayesian networks as an exemplary dynamic program;

FIG. 1b depicts an exemplary equivalent solution of the history dependent traveling salesman problem (TSP) for the computation of the optimal ordering;

FIG. 2a depicts 2-opt moves for the exemplary TSP;

FIG. 2b depicts 3-opt moves for the exemplary TSP;

FIG. 3 depicts an exemplary workflow for automatic learning from data;

FIG. 4 depicts a Bayesian network learned from data for turbine maintenance for an aircraft in an exemplary embodiment;

FIG. 5 depicts a Bayesian network learned from data for HVAC maintenance in an exemplary embodiment;

FIG. 6 depicts a Bayesian network learned for crack occurrences in helicopters in an exemplary embodiment;

FIG. 7 depicts a Bayesian network learned for an influence structure for census data in an exemplary embodiment; and

FIG. 8 illustrates a system for learning a Bayesian network in an exemplary embodiment.

### DESCRIPTION OF EXEMPLARY EMBODIMENTS

Embodiments present a heuristic approach for learning the structure of Bayesian networks from data. Embodiments include computing an ordering of the random variables using a traveling salesman problem (TSP) algorithm. Embodiments provide the opportunity to leverage efficient implementations of TSP algorithms such as the Lin-Kernighan heuristic and cutting plane methods for fast structure learning of Bayesian networks. LKH software is a popular implementation of the Lin-Kernighan heuristic approach. Concorde TSP solver is an efficient implementation of a cutting plane approach coupled with other heuristics. Embodiments use the algorithms for the traveling salesman problem to compute the structure of the Bayesian networks.

In exemplary embodiments, the K2 metric is used to construct the Bayesian network. Embodiments include an assumption that the scoring metric is decomposable,

$$GRAPHSCORE = {\sum }_{x ∈ V} NODESCORE ( x \vert parents ( x ) ) . \qquad ( 1 )$$

Thus, the K2 metric may be replaced with any of the competing scoring functions such as BIC, BDeu, BDe, and minimum description length. A link between the optimal ordering and the TSP can be established on the basis of the decomposable metric. To find the best possible ordering , embodiments start from an empty set φ¹. Embodiments define the cost of going from φ¹ to single random variables to be 0. Similarly, the cost of going from any permutation of all random variables to φ¹ is also defined to be 0. For any partial ordering of random variables (one that does not include all random variables) it is known that,

V(~)=V(~\X)+Cost(X,~\X), (2)

where X is a random variable, V is the value function, ~\X is the set ~without X, and cost(X,~\X) is the cost of adding X to ~\X.

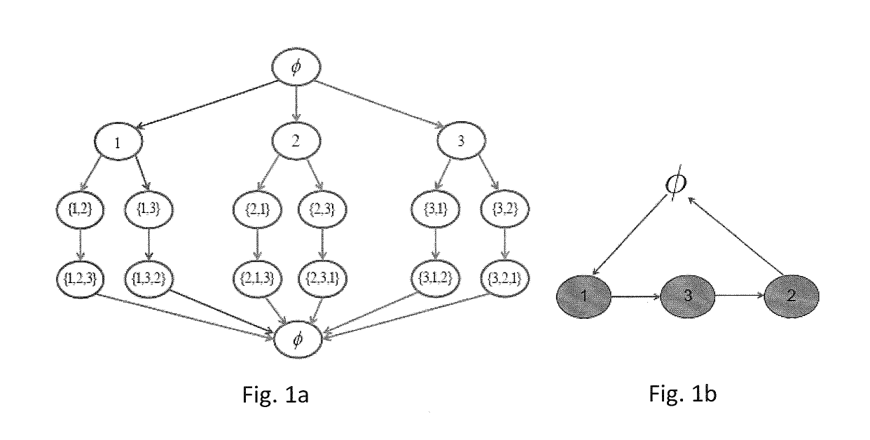

The above dynamic program in Eqn. 2 will require O(n²2ⁿ) operations and computes the cost of computing a parent set for every random variable. Instead of solving the above equation using dynamic programming, embodiments reformulate the problem as a history dependent TSP where the cost of adding a city will be dependent on not only the last city, but the entire history. This is evidenced by Eqn. 2, by considering the random variables as cities of the tour and the optimal ordering of random variables as a tour that minimizes the overall cost (see Eqn. 3 and FIGS. 1a and 1b).

$$V ( 𝕆 ) = min {\sum }_{i = 1}^{N} [ V ( \tilde{𝕆} ( ( i + 1 ) ) ) - V ( \tilde{𝕆} ( i ) ) ] , \qquad ( 3 )$$

The history dependence arises due to the first term in the right hand side of Eqn. 2. An advantage of treating this minimization as a TSP, however, is the ability to leverage pre-existing TSP algorithms such as LKH, as discussed herein. Exemplary embodiments provide Bayesian networks in which the directionality of arrows (causality) may be reversed. This may be attributed to the fact that, given the data, these networks are equally likely.

Embodiments include the computation of the Bayesian network learning cost (e.g., the K2 cost). A random tour through the TSP cities is selected and edges are added or removed based on K2-cost. For any random variable, a k-parent approximation may be taken as the k preceding random variables (in general, embodiments can consider any k random variable subset). Once no new tours can be found, the ordering is used to compute the optimal set of parents for each random variable. This computation takes O(n̂^{k}).

FIG. 1a depicts a structure learning of Bayesian networks as a dynamic program. The permutation tree provides the order in which nodes should be added to the list. FIG. 1b depicts an equivalent solution of the history dependent TSP for the computation of the optimal ordering.

The traveling salesman problem (TSP) is a classic problem that has received attention from the applied mathematics and computer science communities for decades. In the traditional formulation, one is given a list of city positions and tasked with finding a Hamiltonian cycle (a cycle that visits every city only once and returns to the starting city) with lowest cost. Enumerating all possible tours becomes infeasible for problems with more than 10 cities. In particular, the TSP is a well-studied NP-hard problem. Over several decades, many algorithms for computing the solution of the TSP have been developed.

To solve the history dependent TSP, embodiments use Helsgaun's popular version of the Lin-Kernighan Heuristic (LKH). LKH is a randomized approach that picks edges in the tour for removal and adds ones that are “more likely” to be in the optimal tour. If the replacement of edges reduces the cost, the change to the tour is accepted. The likelihood of any edge being in the optimal tour is computed using the α-nearness that is based on minimum 1-trees in the underlying city graph. The LKH is a successful approach for computing the optimal tour of TSPs with asymmetric cost. The LKH may also be used in the setting of the history dependent TSP in exemplary embodiments.

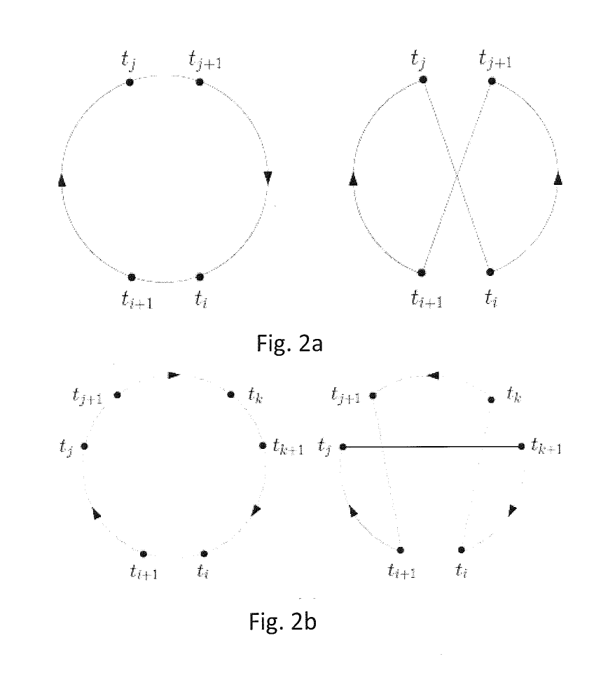

In general, the process replaces k edges in a simple iteration (known as k-opt steps). FIG. 2a depicts 2-opt moves for the TSP. FIG. 2b depicts 3-opt moves for the TSP. Using higher values of k, in general, will give tours with lower cost. However, as k increases, the complexity of the computation increases.

The above approach extends to the history dependent TSP. In exemplary embodiments, edges are deleted and added randomly. Unlike the standard TSP, the acceptance or rejection of the edge replacement is now dependent on the direction as well as on the existing tour. For structure learning of Bayesian networks, the 2-opt and 3-opt iterations may be compared with Helsgaun's implementation of LKH. Despite ignoring history, the standard LKH software performs significantly better than 2-opt and 3-opt implementations with history. This may be due to the fact that LKH uses sequential 5-opt steps as a basic move which is found to provide significantly better results. Helsgaun's LKH software integrated with history dependent costs would be expected to provide more accurate results.

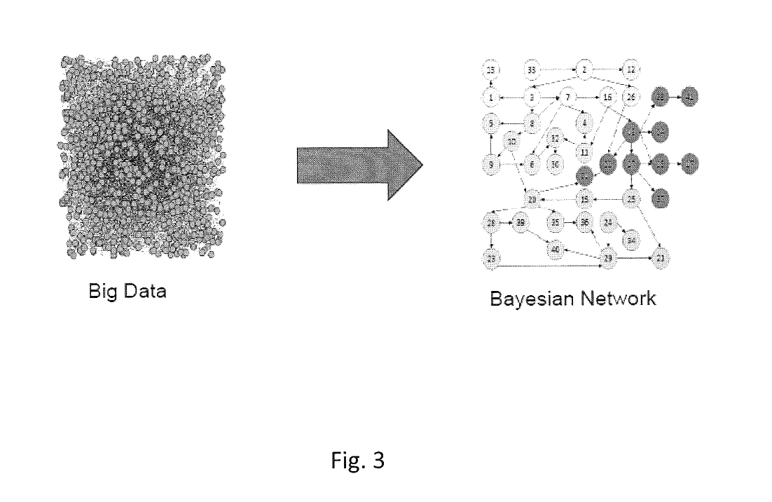

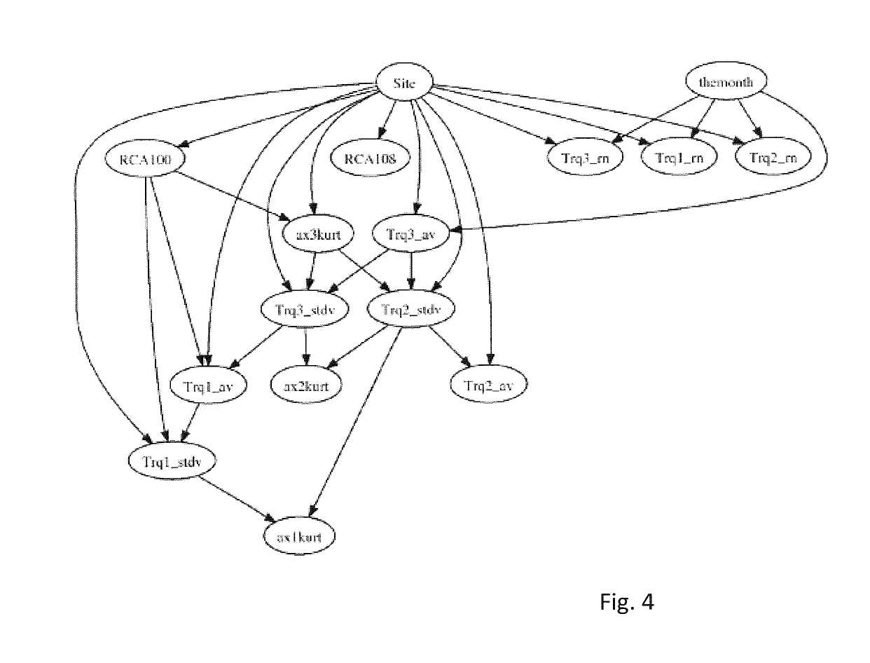

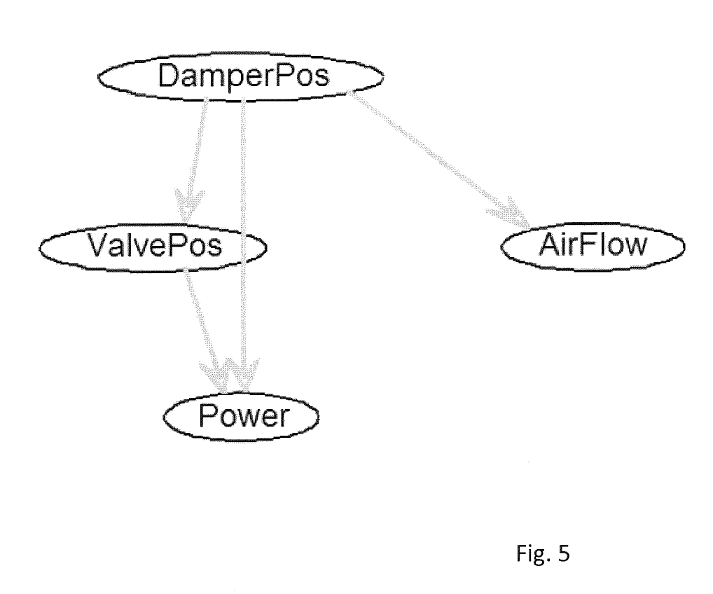

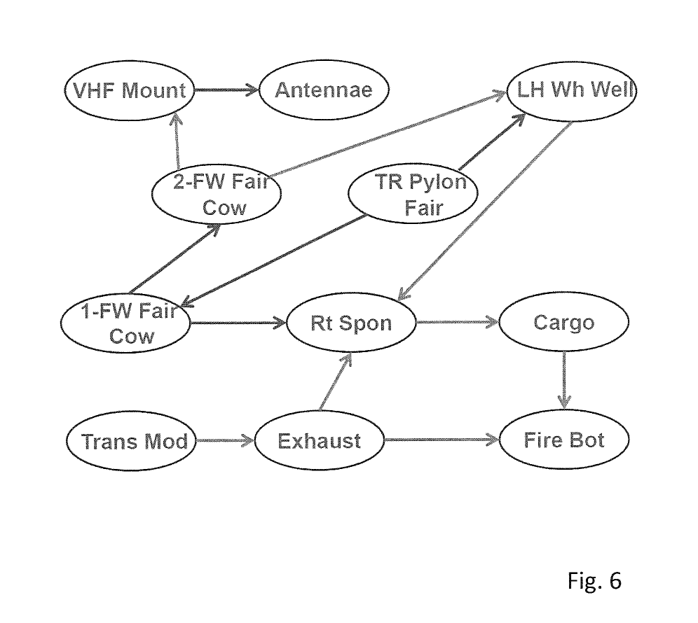

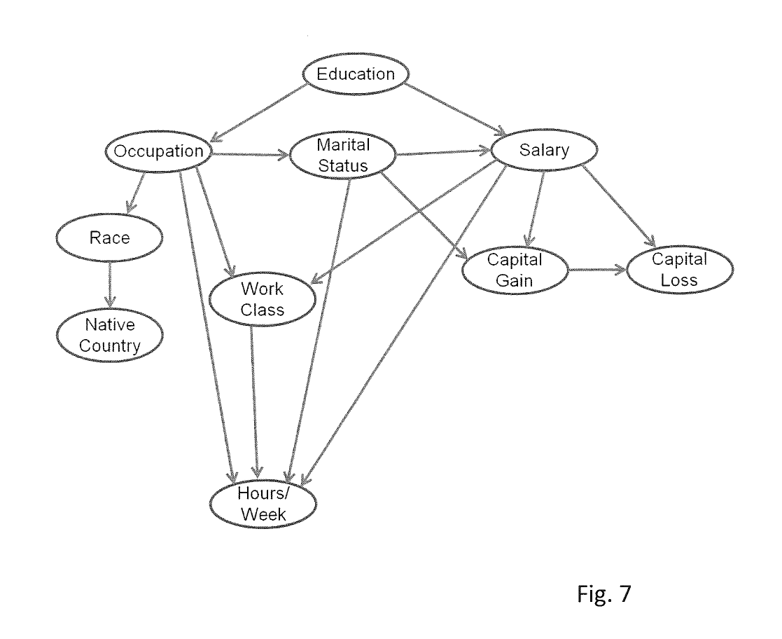

FIG. 3 depicts a workflow for automatic learning from data. Embodiments may be utilized in a variety of applications. For example, FIG. 4 depicts a Bayesian network learned from data for turbine maintenance for an aircraft. FIG. 5 depicts another embodiment of a Bayesian network learned from data for HVAC maintenance. FIG. 6 depicts another embodiment of a Bayesian network learned for crack occurrences in helicopters. FIG. 7 depicts another embodiment of a Bayesian network learned for an influence structure for census data.

It is understood that embodiments may be used in a variety of applications and environments, and embodiments disclosed herein are exemplary.

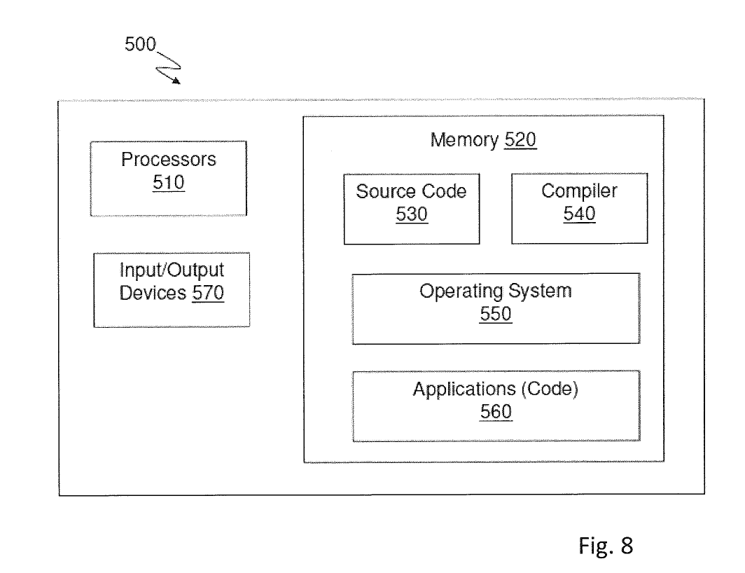

FIG. 8 illustrates an example of an apparatus (i.e., computer 500) having capabilities to implement exemplary embodiments. Various methods, procedures, circuits, elements, and techniques discussed herein may incorporate and/or utilize the capabilities of the computer 500. One or more of the capabilities of the computer 500 may be utilized to implement, to incorporate, to connect to, and/or to support any element discussed herein (as understood by one skilled in the art) in FIGS. 1-7. In exemplary embodiments, computer 500 performs the operations to provide learning of a Bayesian network through a traveling salesman problem algorithm.

Generally, in terms of hardware architecture, the computer 500 may include one or more processors 510, computer readable storage memory 520, and one or more input and/or output (I/O) devices 570 that are communicatively coupled via a local interface (not shown). The local interface can be, for example but not limited to, one or more buses or other wired or wireless connections, as is known in the art. The local interface may have additional elements, such as controllers, buffers (caches), drivers, repeaters, and receivers, to enable communications. Further, the local interface may include address, control, and/or data connections to enable appropriate communications among the aforementioned components.

The processor 510 is a hardware device for executing software that can be stored in the memory 520. The processor 510 can be virtually any custom made or commercially available processor, a central processing unit (CPU), a data signal processor (DSP), or an auxiliary processor among several processors associated with the computer 500, and the processor 510 may be a semiconductor based microprocessor (in the form of a microchip) or a microprocessor.

The computer readable memory 520 can include any one or combination of volatile memory elements (e.g., random access memory (RAM), such as dynamic random access memory (DRAM), static random access memory (SRAM), etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 520 may incorporate electronic, magnetic, optical, and/or other types of storage media. Note that the memory 520 can have a distributed architecture, where various components are situated remote from one another, but can be accessed by the processor 510.

The software in the computer readable memory 520 may include one or more separate programs, each of which comprises an ordered listing of executable instructions for implementing logical functions. The software in the memory 520 includes a suitable operating system (O/S) 550, compiler 540, source code 530, and one or more applications 560 of the exemplary embodiments. As illustrated, the application 560 comprises numerous functional components for implementing the features, processes, methods, functions, and operations of the exemplary embodiments. The application 560 of the computer 500 may represent numerous applications, agents, software components, modules, interfaces, controllers, etc., as discussed herein but the application 560 is not meant to be a limitation.

The operating system 550 may control the execution of other computer programs, and provides scheduling, input-output control, file and data management, memory management, and communication control and related services.

The application 560 may be a source program, executable program (object code), script, or any other entity comprising a set of instructions to be performed. When a source program, then the program is usually translated via a compiler (such as the compiler 540), assembler, interpreter, or the like, which may or may not be included within the memory 520, so as to operate properly in connection with the O/S 550. Furthermore, the application 560 can be written as (a) an object oriented programming language, which has classes of data and methods, or (b) a procedure programming language, which has routines, subroutines, and/or functions.

The I/O devices 570 may include input devices (or peripherals) such as, for example but not limited to, a mouse, keyboard, scanner, microphone, camera, etc. Furthermore, the I/O devices 570 may also include output devices (or peripherals), for example but not limited to, a printer, display, etc. Finally, the I/O devices 570 may further include devices that communicate both inputs and outputs, for instance but not limited to, a NIC or modulator/demodulator (for accessing remote devices, other files, devices, systems, or a network), a radio frequency (RF) or other transceiver, a telephonic interface, a bridge, a router, etc. The I/O devices 570 also include components for communicating over various networks, such as the Internet or an intranet. The I/O devices 570 may be connected to and/or communicate with the processor 510 utilizing Bluetooth connections and cables (via, e.g., Universal Serial Bus (USB) ports, serial ports, parallel ports, FireWire, HDMI (High-Definition Multimedia Interface), etc.).

When the computer 500 is in operation, the processor 510 is configured to execute software stored within the memory 520, to communicate data to and from the memory 520, and to generally control operations of the computer 500 pursuant to the software. The application 560 and the 0/S 550 are read, in whole or in part, by the processor 510, perhaps buffered within the processor 510, and then executed.

When the application 560 is implemented in software, it should be noted that the application 560 can be stored on virtually any computer readable storage medium for use by or in connection with any computer related system or method. The application 560 can be embodied in any computer-readable medium for use by or in connection with an instruction execution system, apparatus, server, or device, such as a computer-based system, processor-containing system, or other system that can fetch the instructions from the instruction execution system, apparatus, or device and execute the instructions.

In exemplary embodiments, where the application 560 is implemented in hardware, the application 560 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

As described above, the exemplary embodiments can be in the form of processor-implemented processes and devices for practicing those processes, such as processor. The exemplary embodiments can also be in the form of computer program code containing instructions embodied in tangible media, such as floppy diskettes, CD ROMs, hard drives, or any other computer-readable storage medium, wherein, when the computer program code is loaded into and executed by a computer, the computer becomes a device for practicing the exemplary embodiments. The exemplary embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the exemplary embodiments. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed for carrying out this invention, but that the invention will include all embodiments falling within the scope of the claims. Moreover, the use of the terms first, second, etc., do not denote any order or importance, but rather the terms first, second, etc., are used to distinguish one element from another. Furthermore, the use of the terms a, an, etc., do not denote a limitation of quantity, but rather denote the presence of at least one of the referenced item.

1. A method of learning a structure of a Bayesian network, the method comprising:
computing an ordering of the random variables of the Bayesian network;
wherein computing the ordering of the random variables of the Bayesian network is performed by computing an approximate solution to the history dependent traveling salesman problem.

2. The method of claim 1 wherein:
applying the traveling salesman problem algorithm includes applying a Lin-Kernighan heuristic.

3. The method of claim 1 wherein:
applying the traveling salesman problem algorithm includes applying a cutting plane method.

4. The method of claim 1 wherein:
applying the traveling salesman problem algorithm includes considering random variables of the Bayesian network as cities of a tour and the optimal ordering of random variables as a tour that minimizes overall cost.

5. The method of any claim 1 wherein:
applying the traveling salesman problem algorithm includes performing a general k-opt iteration on the Bayesian network.

6. An apparatus for learning a structure of a Bayesian network, the apparatus comprising:
a processor; and
memory comprising computer-executable instructions that, when executed by the processor, cause the processor to perform operations for learning the structure of the Bayesian network, the operations comprising:
computing an ordering of the random variables of the Bayesian network;
wherein computing the ordering of the random variables of the Bayesian network is performed by computing an approximate solution to the history dependent traveling salesman problem.

7. The apparatus of claim 6 wherein:
applying the traveling salesman problem algorithm includes applying a Lin-Kernighan heuristic.

8. The method of claim 6 wherein:
applying the traveling salesman problem algorithm includes applying a cutting plane method.

9. The apparatus of claim 6 wherein:
applying the traveling salesman problem algorithm includes considering random variables of the Bayesian network as cities of a tour and the optimal ordering of random variables as a tour that minimizes overall cost.

10. The apparatus of claim 6 wherein:
applying the traveling salesman problem algorithm includes performing a general k-opt iteration on the Bayesian network.

11. A computer program product tangibly embodied on a non-transitory computer readable medium for learning a structure of a Bayesian network, the computer program product including instructions that, when executed by a processor, cause the processor to perform operations comprising:
computing an ordering of the random variables of the Bayesian network;
wherein computing the ordering of the random variables of the Bayesian network is performed by computing an approximate solution to the history dependent traveling salesman problem.

12. The computer program product of claim 11 wherein:
applying the traveling salesman problem algorithm includes applying a Lin-Kernighan heuristic.

13. The computer program product of claim 11 wherein:
applying the traveling salesman problem algorithm includes applying a cutting plane method.

14. The computer program product of claim 11 wherein:
applying the traveling salesman problem algorithm includes considering random variables of the Bayesian network as cities of a tour and the optimal ordering of random variables as a tour that minimizes overall cost.

15. The computer program product of claim 11 wherein:
applying the traveling salesman problem algorithm includes performing a general k-opt iteration on the Bayesian network.
